(19) United States
(12) Patent Application Publication
(10) Pub. No.: US 2026/0236411 A1
(43) Pub. Date: Aug. 13, 2026

(54) APPARATUS AND METHOD FOR REAL-TIME DMA AND MMIO THREAT DETECTION OF EMBEDDED SYSTEMS

(71) Applicant: ELECTRONICS AND TELECOMMUNICATIONS RESEARCH INSTITUTE, Daejeon (KR)

(72) Inventors: Seyoung BAIK, Daejeon (KR); Kyeong-Ho KIM, Daejeon (KR); Sangwook LEE, Daejeon (KR)

(21) Appl. No.: 19/085,194

(22) Filed: Mar. 20, 2025

(30) Foreign Application Priority Data
Feb. 13, 2025 (KR) 10-2025-0018815

(51) Int. Cl. G06F 13/28

(52) U.S. Cl. CPC G06F 13/28; G06F 2213/28

(57) ABSTRACT

Disclosed herein is an apparatus and method for real-time Direct Memory Access (DMA) and Memory-Mapped I/O (MMIO) threat detection of an embedded system. The method may include identifying a protection target in an embedded system and inserting a security module for monitoring the identified protection target, monitoring Direct Memory Access (DMA) to the protection target in real time and collecting security logs by executing the security module inserted into the protection target when the embedded system operates, and analyzing whether the embedded system operates normally and whether there is a potential threat based on the collected security logs when the operation of the embedded system is terminated.

### CROSS REFERENCE TO RELATED APPLICATION

This application claims the benefit of Korean Patent Application No. 10-2025-0018815, filed Feb. 13, 2025, which is hereby incorporated by reference in its entirety into this application.

### BACKGROUND OF THE INVENTION

### 1. Technical Field

The disclosed embodiment relates to security technology of embedded systems.

### 2. Description of Related Art

Direct Memory Access (DMA) is technology that is widely used for performance improvement and real-time guarantee in various embedded devices. DMA enables data transfer by directly accessing memory without the intervention of a CPU, and various external devices operating in conjunction with a processor use DMA. Because of these characteristics, DMA is used to reduce load on CPUs and improve data communication speed and stability, especially in real-time critical systems.

However, because DMA allows direct access to memory without going through a CPU, there is a big threat in terms of system security. Attackers may attempt attacks, such as unauthorized access to a system memory region or unauthorized read or write, by tampering with DMA-related registers or functions. These threats go beyond simple data corruption and may lead to Cyber Physical System (CPS) threats, i.e., physical damage.

Also, because these threats may exploit normal internal system resources, it is difficult to identify them through existing sensor-information-based anomaly detection. Even through post-mortem analysis, it is often impossible to accurately analyze the cause.

Meanwhile, Data Watchpoint and Trace (DWT) is a hardware debugging feature provided by ARM processors, and, using DWT, specific memory addresses or registers related to a DMA control block may be monitored in real time. Accordingly, security threats that can infiltrate Memory-Mapped I/O (MMIO) regions or DMA may be effectively monitored.

In embedded software, wrapper functions are used to generate code of various applications. A wrapper function serves to encapsulate system calls and other low-level system functions, and especially in open-source software, it is often applied through a flat build method. In this method, all code and library functions are integrated and provided as an executable file. Accordingly, there is a threat that bugs or malware may gain access from a user space to a kernel space. Therefore, in such a development environment, additional security technology for enhancing system security is required.

### SUMMARY OF THE INVENTION

An object of the disclosed embodiment is to detect potential threats that may occur in an embedded device in which DMA is applied and to provide post-mortem analysis technology through logging in an environment such as a flat build, which is convenient but vulnerable to security threats.

A method for real-time Direct Memory Access (DMA) and Memory-Mapped I/O (MMIO) threat detection of an embedded system according to an embodiment may include identifying a protection target in an embedded system and inserting a security module for monitoring the identified protection target, monitoring Direct Memory Access (DMA) to the protection target in real time and collecting security logs by executing the security module inserted into the protection target when the embedded system operates, and analyzing whether the embedded system operates normally and whether there is a potential threat based on the collected security logs when operation of the embedded system is terminated.

Here, the protection target may include a DMA communication path and an MMIO register.

Here, the security module may include a software module for monitoring at least one DMA wrapper function and recording a relevant parameter when the at least one DMA wrapper function is called; and a kernel for storying a DMA history by monitoring the protection target in real time based on a Data Watchpoint and Trace (DWT).

Here, collecting the security logs may include triggering an exception by detecting a call of a DMA wrapper function based on a DWT and recording a return address and a parameter of the wrapper function that attempts the DMA as the security log through an exception handler function when the exception occurs.

Here, triggering the exception may comprise verifying whether an exception is triggered by the DWT by checking an Interrupt Program Status Register (IPSR).

Here, triggering the exception may comprise determining that the exception is triggered by the DWT when the value of the IPSR is 12.

Here, the security log may include a first record for storing information about the return address when an MMIO region is accessed through the DMA; and a second record for periodically storing the parameter through a preset DMA wrapper function.

Here, analyzing whether the embedded system operates normally and whether there is a potential threat may include identifying a source of the DMA through the return address of the first record and identifying whether the DMA is abnormal access; and identifying whether there is abnormal access by analyzing whether the parameter stored in the second record falls outside an expected range and matches the normal number of calls.

An apparatus for real-time DMA and MMIO threat detection of an embedded system according to an embodiment includes memory in which at least one program is recorded and a processor for executing the program, and the processor may identify a protection target in an embedded system, insert a security module for monitoring the identified protection target, monitor Direct Memory Access (DMA) to the protection target in real time and collect security logs by executing the security module inserted into the protection target when the embedded system operates, and analyze whether the embedded system operates normally and whether there is a potential threat based on the collected security logs when operation of the embedded system is terminated.

Here, the protection target may include a DMA communication path and an MMIO register.

Here, the security module may include a software module for monitoring at least one DMA wrapper function and recording a relevant parameter when the at least one DMA wrapper function is called; and a kernel for storying a DMA history by monitoring the protection target in real time based on a Data Watchpoint and Trace (DWT).

Here, the processor may trigger an exception by detecting a call of a DMA wrapper function based on a DWT and record a return address and a parameter of the wrapper function that attempts the DMA as the security log through an exception handler function when the exception occurs.

Here, the processor may verify whether an exception is triggered by the DWT by checking an Interrupt Program Status Register (IPSR).

Here, the processor may determine that the exception is triggered by the DWT when the value of the IPSR is 12.

Here, the security log may include a first record for storing information about the return address when an MMIO region is accessed through the DMA; and a second record for periodically storing the parameter through a preset DMA wrapper function.

Here, when analyzing whether the embedded system operates normally and whether there is a potential threat based on the collected security logs, the processor may identify a source of the DMA through the return address of the first record, identify whether the DMA is abnormal access, and identify whether there is abnormal access by analyzing whether the parameter stored in the second record falls outside an expected range and matches the normal number of calls.

A method for real-time DMA and MMIO threat detection of an embedded system according to an embodiment may include identifying a protection target in an embedded system and inserting a security module for monitoring the identified protection target, triggering an exception by detecting a call of a DMA wrapper function based on a DWT by executing the security module inserted into the protection target when the embedded system operates, recording a return address and a parameter of a wrapper function that attempts DMA as a security log through an exception handler function when the exception occurs, identifying a source of the DMA through the return address and identifying whether the DMA is abnormal access, and identifying whether there is abnormal access by analyzing whether the parameter falls outside an expected range and matches the normal number of calls.

Here, the security module may include a software module for monitoring at least one DMA wrapper function and recording a relevant parameter when the at least one DMA wrapper function is called; and a kernel for storying a DMA history by monitoring the protection target in real time based on the Data Watchpoint and Trace (DWT).

Here, triggering the exception may comprise verifying whether an exception is triggered by the DWT by checking an Interrupt Program Status Register (IPSR).

Here, the security log may include a first record for storing information about the return address when an MMIO region is accessed through the DMA; and a second record for periodically storing the parameter through a preset DMA wrapper function.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a flowchart for explaining a method for real-time DMA and MMIO threat detection of an embedded system according to an embodiment;

FIG. 2 is a flowchart for explaining in detail a protection target identification and system porting step (S110) according to an embodiment;

FIG. 3 is a flowchart for explaining in detail a real-time monitoring and security log collection step (S130) according to an embodiment;

FIG. 4 is a flowchart for explaining a real-time monitoring and security log collection process according to an embodiment;

FIG. 5 is a flowchart for explaining in detail a step (S150) of analyzing whether there is a threat according to an embodiment; and

FIG. 6 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

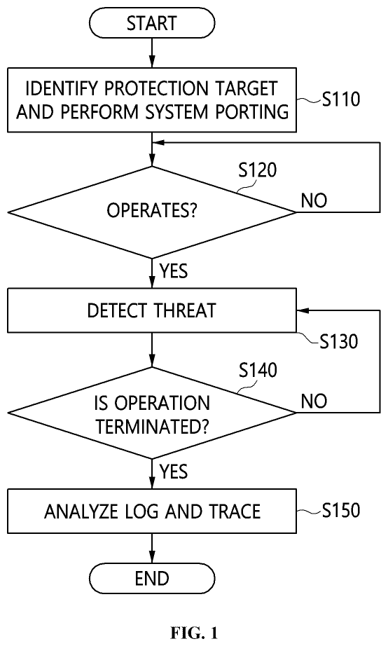

FIG. 1 is a flowchart for explaining a method for real-time DMA and MMIO threat detection of an embedded system according to an embodiment.

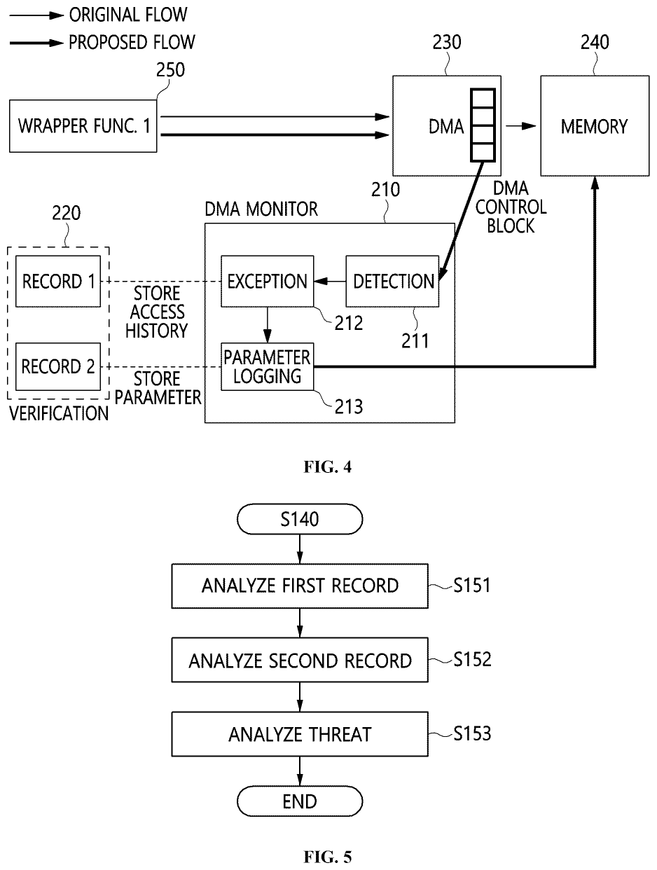

Referring to FIG. 1, the method for real-time DMA and MMIO threat detection of an embedded system according to an embodiment may include identifying a protection target in an embedded system and inserting a security module for monitoring the identified protection target at step S110 (FIG. 3), monitoring Direct Memory Access (DMA) to the protection target in real time and collecting security logs by executing the security module inserted into the protection target at step S130 (FIG. 4) as the embedded system operates at step S120, and analyzing whether the embedded system operates normally and whether there is a potential threat based on the collected security logs at step S150 (FIG. 5) as the operation of the embedded system is terminated at step S140.

The protection target identification and system porting step (S110) according to an embodiment may be a preparation step for the embedded system to respond to threats that can occur in DMA and MMIO regions.

Here, an embedded device may be a device that uses Direct Memory Access (DMA) in unmanned vehicles such as drones, robots, satellites, and the like.

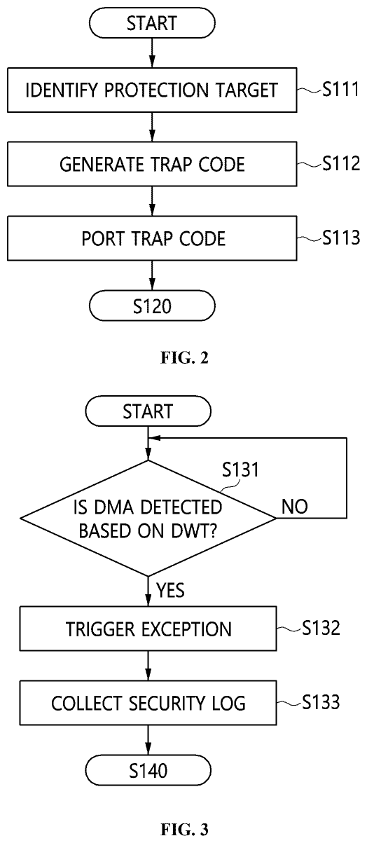

FIG. 2 is a flowchart for explaining the protection target identification and system porting step (S110) according to an embodiment in detail.

Referring to FIG. 2, at the protection target identification and system porting step (S110) according to an embodiment, first, a memory region that needs to be protected in the embedded system is identified as a protection target at step S111. To this end, the range of memory addresses used by DMA, accessible external devices, main registers of the MMIO region, and the like may be analyzed.

Here, the protection target may include a DMA communication path and MMIO registers.

Subsequently, at the protection target identification and system porting step (S110) according to an embodiment, a security module for performing monitoring and security functions for the identified protection target is generated as trap code at step S112, and the generated trap code is inserted into the protection target at step S113.

Here, two security modules may be generated according to an embodiment.

The first security module is a software module for monitoring at least one DMA wrapper function and recording a relevant parameter when the at least one DMA wrapper function is called, and this is a software patch for monitoring main low-level wrapper functions.

This is for identifying disallowed wrapper functions based on the idea that DMA usually uses wrapper functions to access MMIO. Accordingly, when the corresponding functions are called, relevant parameters may be recorded and used for post-analysis.

Also, the security module may include a kernel for storing a DMA history by monitoring the protection target in real time based on a Data Watchpoint and Trace (DWT).

This is a kernel patch for utilizing a DWT feature provided by ARM processors, and this supports the DWT function to monitor a DMA control block and an MMIO region in real time and provides a function to store a history of access to the protected memory region. Accordingly, detection and security logs for the monitoring targets may be generated.

Also, at the real-time monitoring and security log collection step (S130) according to an embodiment, the security function that is inserted into the embedded device to be operated is applied in practice, whereby access to the target region to be protected is monitored in real time and a security log is generated.

FIG. 3 is a flowchart for explaining in detail the real-time monitoring and security log collection step (S130) according to an embodiment, and FIG. 4 is a flowchart for explaining a real-time monitoring and security log collection process according to an embodiment.

Referring to FIG. 3, at the real-time monitoring and security log collection step (S130), an exception is triggered at step S132 when a call of a DMA wrapper function is detected based on a DWT at step S131.

That is, referring to FIG. 4, the conventional method allows access to memory 240 using DMA 230 of a DMA wrapper function 250, but in the present disclosure, the access to the memory 240 using the DMA 230 of the DMA wrapper function 250 is detected (211) by a DMA monitoring unit 210.

Here, triggering the exception may comprise verifying whether an exception is triggered by a DWT by checking an Interrupt Program Status Register (IPSR).

Here, triggering the exception may comprise determining that the exception is triggered by a DWT when the value of the IPSR is 12.

Subsequently, at the real-time monitoring and security log collection step (S130), the return address and the parameter of the wrapper function that attempts the DMA are recorded as a security log through an exception handler function at step S133 when the exception occurs. That is, when the corresponding handler function is called in response to the exception, the return addresses and parameter values of the functions that attempted the DMA are stored on an SD card.

Referring to FIG. 4, the security log 220 may include a first record and a second record.

Here, the first record may store the return address information when the MMIO region is accessed through DMA. This may be used to track the source of each access in the future analysis step.

Also, the second record may periodically store parameters through a preset DMA wrapper function. This may be used to determine whether a parameter manipulation attack is carried out and to perform cross-checking with the first record.

Finally, when the operation is terminated, the security log data stored in the nonvolatile storage device is uploaded to a dedicated PC-based application, and whether the system operates normally and whether there is a potential threat are analyzed based on the collected security logs.

FIG. 5 is a flowchart for explaining in detail the step (S150) of analyzing whether there is a threat according to an embodiment.

Referring to FIG. 5, at the analysis step according to an embodiment, the source of DMA is identified through the return address of the first record, and whether the DMA is abnormal access is identified at step S151.

Subsequently, at the analysis step according to an embodiment, whether there is abnormal access is identified by analyzing whether the parameter stored in the second record falls outside an expected range and matches the normal number of calls at step S152. That is, whether a predefined valid parameter value and a function call pattern match the value stored in the second record is checked through comparison, and when the parameter falls outside the expected range or does not match the normal number of calls, the access is regarded as abnormal access.

Through the above-described double checking, security of the protection target may be enhanced.

For example, when the first record contains a record that a specific memory region is accessed, whether the parameter value used for the access, which is stored in the second record, is valid may be verified by analyzing the parameter value. Also, even though the accessed memory region is allowed to be accessed, when the parameter value stored in the second record falls outside the expected range, the access may be regarded as malicious access and detected as a threat.

Hereinafter, examples of implementing the respective steps of the method for real-time DMA and MMIO threat detection of an embedded system as program code will be described.

(1) analysis of record1

Role: The address value from which access to a DMA control block is attempted and detailed data related thereto.

Implementation method: Using a watchpoint, the value of an Interrupt Program Status Register (IPSR) is checked in response to the exception that occurs in the event of DMA access. When the value of the IPSR is a specific value (e.g., a number corresponding to the watchpoint), it is confirmed that the exception is triggered by the watchpoint. Accordingly, DMA access in the kernel space may be effectively monitored and recorded. Detailed information on the DMA access attempt, including a return address, is stored, whereby the function attempting the DMA access may be tracked.

Table 1 below shows an example of normal DMA access, and Table 2 shows an example of abnormal DMA access.

TABLE 1
JSON
{
“return_address”: “0x0800ABCD”, // valid memory address
“timestamp”: 1000,
“dma_access_address”: “0x20000000”.
“access method”: “write”,
“ipsr_value”: 12
}

TABLE 2
JSON
{
“return_address”: “0x0800EF01”, // not a valid memory address, malicious
“timestamp”: 1001,
“dma_access_address”: “0xDEADBEEF”, // untrusted data access
“access_method”: “read”,
“ipsr_value”: 12
}
}

### (2) Analysis of Record2

Role: Data storing the name of the called wrapper function and the parameter value passed to the corresponding function.

Implementation method: A source code patch is applied to the main wrapper function before the embedded device operates, whereby the parameter value required for the call is verified and recorded.

Table 3 below shows an example of a normal wrapper function call, and Table 4 shows an example of an abnormal wrapper function call.

```
TABLE 3
JSON
{
“function_name”: “DMA_Setup”, // name of previously used wrapper function
“parameters”: {
  “source”: “0x20000000”,
  “destination”: “0x40021000”,
  “length”: 128
}
}
```

```
TABLE 4
JSON
{
“function_name”: “Malicious_DMA_Setup”, // suspected wrapper function name
“parameters”: {
  “source”: “OxDEADBEEF”, // not a valid memory address
  “destination”: “0x40021000”,
  “length”: 128
}
}
```

### (3) Identification of Protection Target and Generation of Trap Code by Watchpoint

This embodiment describes the process of performing security monitoring of internal registers and peripherals in the initialization step and monitoring main DMA and peripheral-related registers in the operation step for a Pixhawk vox flight controller.

Table 5 shows an example of implementation code for record1.

TABLE 5

| #Step1 , define exception | |
|---|---|
| EXCEPTION_CHECK: | |
| mrs | r0, ipsr |
| cmp | r0, #12 |
| beq | EXCEPTION_HANDLER |
| b | NORMAL EXECUTION |

The interrupt status is checked through the ipsr as shown in Table 5. If the value of the ipsr is 12, the process jumps to EXCEPTION_HANDLER, but if the value is not 12, it continues with normal execution.

TABLE 6

| #Step2. Stack Context Handling | |
|---|---|
| EXCEPTION_HANDLER: | |
| tst | lr, #4 |
| ite | eq |
| mrseq | r0, msp |
| mrsne | r0, psp |
| b | RETURN_ADDRESS_LOGGING |

As shown in Table 6, the third bit of the EXC_RETURN value is checked to determine if the value is an MSP or a PSP in the EXCEPTION_HANDLER. Then, the stack pointer (sp) value is stored in r0 by branching depending on the result. Subsequently, the following logging step proceeds as shown in Table 7.

TABLE 7

| #Step3. Return Address Logging | |
|---|---|
| RETURN_ADDRESS_LOGGING: | |
| mov | r0, r14 |
| bl | store_logging_address |
| b | EXCEPTION_EXIT |
| #example of store_logging_address function | |
| store_logging_address | |
| push | {lr} |
| ldr | r1, = LOG_BUFFER |
| str | r0, [r1] |
| pop | {lr} |
| bx | lr |

In the RETURN ADDRESS LOGGING step in Table 7, the value of r14 is copied to r0, whereby the return address is passed to the ‘store_logging_address’ function as an argument. Through the instruction ‘bl store_logging_address’, the process jumps to the ‘store_logging_address’ function, and the return address contained in r0 is passed to the log processing function. The ‘store_logging_address’ function records the return address contained in r0 in a log buffer and returns to the original flow through the instruction for return from the function. Table 8 shows an example of code implemented for record2. Here, record2 works by recording the parameter that is passed when the wrapper function is called and by then calling the original function.

TABLE 8

| do_dma_transfer: | |
|---|---|
| [existing code area for DMA transfer] | |
| bx | lr |
| do_dma_transfer_wrapper: | |
| push | {r0-r3, lr} |
| @parameter logging (store in record2) | |
| mov | r0, 0 |
| bl | log_parameter |
| mov | ro, r1 |
| bl | log_parameter |
| pop | {r0-r3, lr} |
| bl | do_dma_transfer |
| bx | lr |
| log_parameter: | |
| push | {lr} |
| ldr | r1, = RECORD2_BUFFER |
| str | r0, [r1], #4 |
| pop | {lr} |
| bx | lr |

As shown in Table 8, when parameters are passed to do_dma_transfer_wrapper, each of the parameters is passed to the ‘log_parameter’ function and recorded in record2. After parameter logging is complete, the original DMA transfer function is called. When the DMA transfer is complete, the process returns to the address from which it was called.

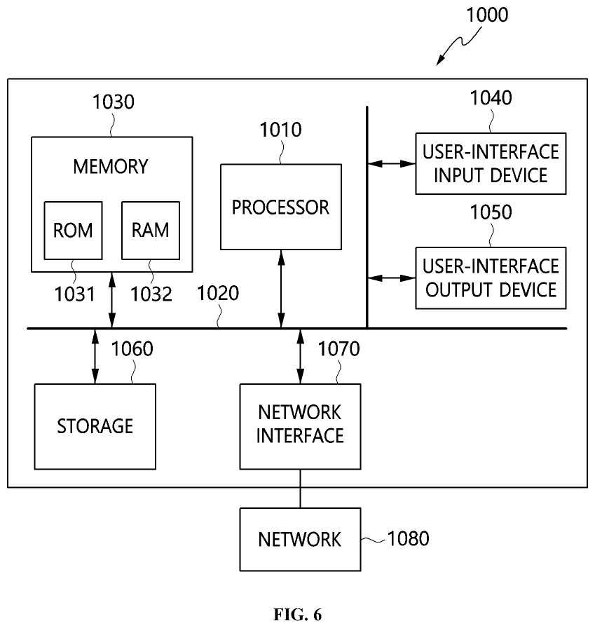

FIG. 6 is a view illustrating a computer system configuration according to an embodiment.

The apparatus for real-time DMA and MMIO threat detection of an embedded system according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, real-time security threat tracking and post-mortem analysis may be enhanced. That is, in embedded systems, calls of functions related to DMA and MMIO regions, parameter information, and a return address stored on a stack in the event of an exception may be generated as a security log. Accordingly, attempts to access the regions and functions protected by the system, abnormal memory access, or the like may be recorded and tracked, which is useful for a proactive response, post-mortem analysis, and inspection. Particularly, it is possible to quickly detect security threats through real-time monitoring and to perform necessary measures.

Also, according to the disclosed embodiment, portability to existing systems and performance thereof may be optimized. In other words, the patching method according to the disclosed embodiment does not change the existing kernel structure, so it can be easily ported to and integrated into existing embedded systems. Particularly, using a hardware-based watchpoint function, threats related to DMA and MMIO may be detected with minimized system overhead. It is highly scalable in that it is possible to utilize existing hardware resources without additional systems.

Also, according to the disclosed embodiment, it is possible to protect MMIO and to detect DMA threats. In other words, the disclosed embodiment is used to protect the MMIO regions and provides the capability to detect and track security threats related to DMA in real time, especially in flat build environments. In existing systems, the method of detecting and tracking DMA-related operations was limited, but the present disclosure enables threats caused by DMA to be clearly tracked and analyzed, whereby system security may be enhanced.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. A method for real-time Direct Memory Access (DMA) and Memory-Mapped I/O (MMIO) threat detection of an embedded system, comprising:
identifying a protection target in an embedded system and inserting a security module for monitoring the identified protection target;
monitoring Direct Memory Access (DMA) to the protection target in real time and collecting security logs by executing the security module inserted into the protection target when the embedded system operates; and
analyzing whether the embedded system operates normally and whether there is a potential threat based on the collected security logs when operation of the embedded system is terminated.

2. The method of claim 1, wherein the protection target includes a DMA communication path and an MMIO register.

3. The method of claim 1, wherein the security module includes:
a software module for monitoring at least one DMA wrapper function and recording a relevant parameter when the at least one DMA wrapper function is called; and
a kernel for storing a DMA history by monitoring the protection target in real time based on a Data Watchpoint and Trace (DWT).

4. The method of claim 1, wherein collecting the security logs comprises:
triggering an exception by detecting a call of a DMA wrapper function based on a Data Watchpoint and Trace (DWT); and
recording a return address and a parameter of the wrapper function that attempts the DMA as the security log through an exception handler function when the exception occurs.

5. The method of claim 4, wherein triggering the exception comprises verifying whether an exception is triggered by the DWT by checking an Interrupt Program Status Register (IPSR).

6. The method of claim 5, wherein triggering the exception comprises determining that the exception is triggered by the DWT when a value of the IPSR is 12.

7. The method of claim 4, wherein the security log includes:
a first record for storing information about the return address when an MMIO region is accessed through the DMA; and
a second record for periodically storing the parameter through a preset DMA wrapper function.

8. The method of claim 7, wherein analyzing whether the embedded system operates normally and whether there is a potential threat comprises:
identifying a source of the DMA through the return address of the first record and identifying whether the DMA is abnormal access; and
identifying whether there is abnormal access by analyzing whether the parameter stored in the second record falls outside an expected range and matches a normal number of calls.

9. An apparatus for real-time Direct Memory Access (DMA) and Memory-Mapped I/O (MMIO) threat detection of an embedded system, comprising:
memory in which at least one program is recorded; and
a processor for executing the program,
wherein the processor identifies a protection target in an embedded system, inserts a security module for monitoring the identified protection target, monitors Direct Memory Access (DMA) to the protection target in real time and collects security logs by executing the security module inserted into the protection target when the embedded system operates, and analyzes whether the embedded system operates normally and whether there is a potential threat based on the collected security logs when operation of the embedded system is terminated.

10. The apparatus of claim 9, wherein the protection target includes a DMA communication path and an MMIO register.

11. The apparatus of claim 9, wherein the security module includes:
a software module for monitoring at least one DMA wrapper function and recording a relevant parameter when the at least one DMA wrapper function is called; and
a kernel for storing a DMA history by monitoring the protection target in real time based on a Data Watchpoint and Trace (DWT).

12. The apparatus of claim 9, wherein the processor triggers an exception by detecting a call of a DMA wrapper function based on a Data Watchpoint and Trace (DWT), and when the exception occurs, the processor records a return address and a parameter of the wrapper function that attempts the DMA as the security log through an exception handler function.

13. The apparatus of claim 12, wherein the processor verifies whether an exception is triggered by the DWT by checking an Interrupt Program Status Register (IPSR).

14. The apparatus of claim 13, wherein the processor determines that the exception is triggered by the DWT when a value of the IPSR is 12.

15. The apparatus of claim 12, wherein the security log includes:
a first record for storing information about the return address when an MMIO region is accessed through the DMA; and
a second record for periodically storing the parameter through a preset DMA wrapper function.

16. The apparatus of claim 15, wherein, when analyzing whether the embedded system operates normally and whether there is a potential threat based on the collected security logs, the processor identifies a source of the DMA through the return address of the first record, identifies whether the DMA is abnormal access, and identifies whether there is abnormal access by analyzing whether the parameter stored in the second record falls outside an expected range and matches a normal number of calls.

17. A method for real-time Direct Memory Access (DMA) and Memory-Mapped I/O (MMIO) threat detection of an embedded system, comprising:
identifying a protection target in an embedded system and inserting a security module for monitoring the identified protection target;
triggering an exception by detecting a call of a DMA wrapper function based on a Data Watchpoint and Trace (DWT) by executing the security module inserted into the protection target when the embedded system operates;
recording a return address and a parameter of the wrapper function that attempts DMA as a security log through an exception handler function when the exception occurs;
identifying a source of the DMA through the return address and identifying whether the DMA is abnormal access; and
identifying whether there is abnormal access by analyzing whether the parameter falls outside an expected range and matches a normal number of calls.

18. The method of claim 17, wherein the security module includes:
a software module for monitoring at least one DMA wrapper function and recording a relevant parameter when the at least one DMA wrapper function is called; and
a kernel for storing a DMA history by monitoring the protection target in real time based on the Data Watchpoint and Trace (DWT).

19. The method of claim 17, wherein triggering the exception comprises verifying whether an exception is triggered by the DWT by checking an Interrupt Program Status Register (IPSR).

20. The method of claim 17, wherein the security log includes:
a first record for storing information about the return address when an MMIO region is accessed through the DMA; and
a second record for periodically storing the parameter through a preset DMA wrapper function.
